(19) United States
(12) Patent Application Publication
(10) Pub. No.: US 2005/0121613 A1
(43) Pub. Date: Jun. 9, 2005

(54) Laser beam machining method

(76) Inventors: Kenji Ito, Tokyo (JP); Shozui Takeno, Tokyo (JP); Nobutaka Kobayashi, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/500,253

(22) PCT Filed: Mar. 17, 2003
(86) PCT No.: PCT/JP03/03132

(51) Int. Cl. H01T 19/04

(52) U.S. Cl. 250/324

(57) ABSTRACT

A laser material processing method for processing a printed wiring board to form a blind hole, a groove or a through hole by applying a laser beam to an insulating layer of the printed wiring board includes a first step of processing the insulating layer at a predetermined energy density, a second step of hardening the insulating layer by applying a laser beam at a lower energy density than the predetermined energy density of the first step around a processed portion processed in the first step, and a third step of removing the residual smear.

### TECHNICAL FIELD

The present invention relates to a laser material processing method for processing a laminated material to form a through hole or blind hole for electrical connection of a plurality of conductor layers in a laminated wiring board, called a printed wiring board, having an insulating layer typically made of epoxy resin or polyimide resin and a conductor layer made from a copper foil.

### BACKGROUND ART

Conventionally, in forming a blind hole for electrical connection through an insulating layer in a printed wiring board, first of all, a carbon dioxide gas laser beam is applied to the insulating layer to process (remove) the insulating layer, and then a conductor layer is deposited by electroplating to form an electric circuit of lamination type.

Herein, in depositing the conductor layer, if there is any resin smear on a bottom face of a processed hole, electroplating is degraded in the tightness of contact, possibly causing a disconnection due to heating by soldering or temperature changes during the use.

Thus, the conventional resin smear removal process involves washing away the residual resin smear through a chemical treatment of dipping the board with processed hole into an organic solution. In the chemical treatment, concentrated sulfuric acid, chromic acid and potassium permanganate are employed.

A carbon dioxide gas laser material processing method for processing the printed wiring board was disclosed in JP-A-10-12997 (refer to patent document 1).

Also, another laser material processing method for removing the smear by applying a laser beam larger than a processed hole after forming the hole by laser beam was disclosed in JP-A-10-173318 (refer to patent document 2).

Patent document 1: JP-A-10-12997

Patent document 2: JP-A-10-173318

In the conventional carbon dioxide gas laser material processing method as disclosed in patent document 1, there was in some cases a damage such as “defect” at the edge portion of a processed hole due to a flow pressure that is increased at the edge portion of the processed hole opened by laser irradiation during liquid treatment in the smear removal process.

As a result, there was a problem that the electrical characteristics were less stable due to a dispersion in the cross-sectional area of the processed holes intended to make interlayer connection for connecting the conductor layers on the surface and bottom face. (The resistance value is inversely proportional to the cross-sectional area of the processed hole.)

Also, in the conventional laser material processing method as disclosed in patent document 2, the smear is removed by applying laser beam without liquid treatment in the smear removal process, but the plating process after the smear removal process necessarily requires an impurity removal process by liquid or a degreasing process by alkaline solution, whereby there was in some cases a damage at an edge portion of the processed hole due to a flow pressure of the liquid as in patent document 1.

For reference, when an excimer laser having a wavelength of 0.249 μm is employed to apply a laser beam greater than the processed hole, the laser ablation processing has almost no thermal effect to remove the smear, whereby the laser beam of that energy can not produce a hardened layer on the resin layer around the processed hole.

The laser ablation processing has a feature that no heat affected layer is produced because electrons residing between bonded molecules are directly vibrated by electric field components of the laser beam to decompose the layer.

In the case where a carbon dioxide gas laser beam having a wavelength of 10.6 μm is applied, the hardened layer can be produced without removal, depending on the conditions of laser beam, because the bonded molecules themselves are vibrated due to electric field components of the laser beam to generate a heat and decompose the layer by the heat.

### DISCLOSURE OF THE INVENTION

This invention has been achieved to solve the above-mentioned problems, and it is an object of the invention to provide a carbon dioxide gas laser material processing method for processing a printed wiring board with a stable cross-sectional area (resistance value) of a processed hole by preventing a damage in the processed hole in a liquid treatment in a smear removal process after the processing by laser beam.

In order to accomplish the above object, according to a first aspect of the invention, there is provided a laser material processing method for processing a printed wiring board to form a blind hole, a groove or a through hole by applying a laser beam to an insulating layer of the printed wiring board, including a first step of processing the insulating layer at a predetermined energy density, a second step of hardening the insulating layer by applying a laser beam at a lower energy density than the predetermined energy density of the first step around a processed portion processed in the first step, and a third step of removing the residual smear.

Also, the energy density may be 0.5 J/cm² or less in the second step.

Also, the energy density maybe 0.6 J/cm² or less in applying laser beam to the insulating layer made of polyimide resin in the second step.

Also, the area to apply laser beam in the second step may be about double the processed area in the first step.

Also, a carbon dioxide gas laser having a wavelength of 10.6 μm may be used for the laser material processing.

According to a second aspect of the invention, there is provided a laser material processing method for processing a printed wiring board to form a blind hole, a groove or a through hole by applying a laser beam to an insulating layer of the printed wiring board, including a first step of processing the insulating layer at an energy density of 15 J/cm², a second step of hardening the insulating layer by applying a laser beam at an energy density of 15 J/cm² or less around a processed portion processed in the first step, and a third step of removing the residual smear.

Also, one pulse of laser beam may be applied for a pulse beam on time of 10 μs in the second step.

### BRIEF DESCRIPTION OF THE DRAWINGS

FIG. 1 is a view showing the process transition of a laser material processing method according to a first embodiment of the present invention.

FIG. 2 is a graph showing the relationship between the energy density and the depth of processed hole for epoxy resin.

FIG. 3 is a graph showing the relationship between the energy density and the depth of processed hole for polyimide resin.

FIG. 4 is a view showing the process transition of a laser material processing method according to a second embodiment of the invention.

FIG. 5 is a view showing the process transition of the conventional laser material processing method.

### BEST MODE FOR CARRYING OUT THE INVENTION

### Embodiment 1

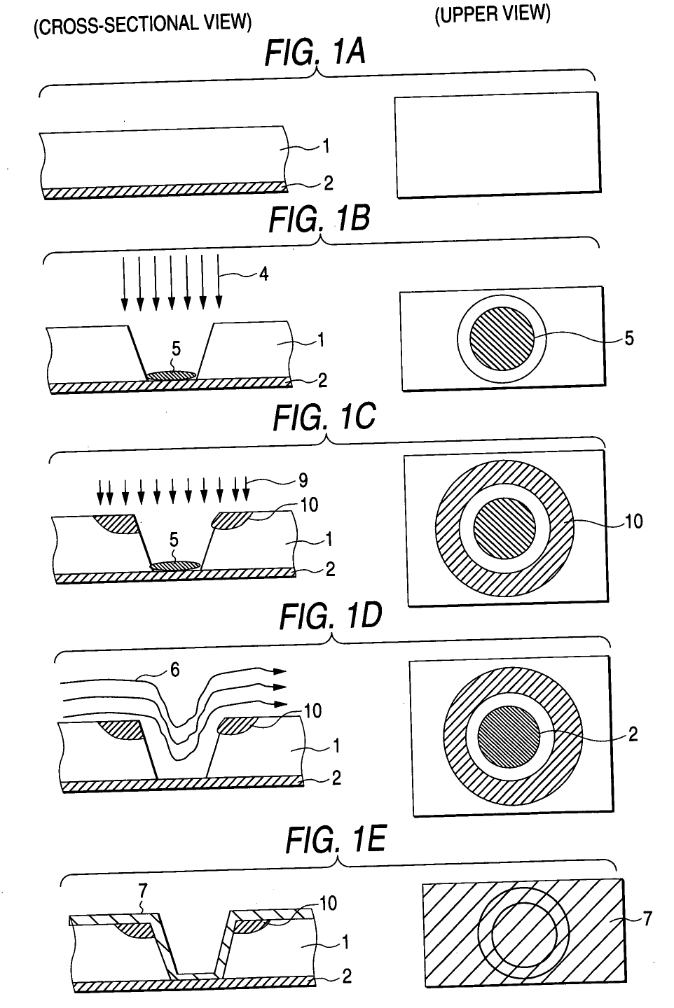

Referring to FIG. 1, a carbon dioxide gas laser material processing method for processing a laminated material according to a first embodiment of the present invention will be described below.

In this embodiment, a printed wiring board has an insulating layer 1 made of epoxy resin and a conductor layer 2 made from a copper foil provided on the back face of the insulating layer 1, in which a blind hole up to the conductor layer 2 is formed through the insulating layer 1.

The printed wiring board is a glass cloth impregnated in the insulating layer, or a laminated plate of multiple layers.

Herein, the printed wiring board is processed by the carbon dioxide gas laser material processing method for laminated material, and consists of the insulating layer 1 made of epoxy resin having a thickness of 60 μm and the conductor layer 2 made from a copper foil having a thickness of 18 μm, as shown in FIG. 1A.

The intended hole diameter of blind hole is φ80 μm.

First of all, as the first laser irradiation, a carbon dioxide gas laser beam 4 having a pulse beam on time of 10 μs and an energy density of 15 J/cm² is applied by two pulses to the insulating layer 1 in an area of φ80 μm to form a hole in the insulating layer 1 (see FIG. 1B).

Then, as the second laser irradiation, a carbon dioxide gas laser beam 9 having a pulse beam on time of 10 μs and an energy density of 0.4 J/cm² is applied by one pulse in an area of φ150 μm to harden the surface of the insulating layer 1 around the processed hole and form a resin hardened layer 10 (see FIG. 1C).

Thereafter, a smear removal process using potassium permanganate 6 is performed to remove a smear 5 remaining on the surface of the conductor layer 2 after forming the hole (see FIG. 1D).

Lastly, a plating process including liquid treatments through an impurity removal process and a degreasing process to make a plating 7, whereby the via hole formation for the printed wiring board is completed (see FIG. 1E).

In a table below, the first laser irradiation conditions are such that the pulse beam on time is 10 μs, the energy density is 15 J/cm², the number of pulses is two, and the irradiated area is φ80 μm, and the second laser irradiation conditions are such that the pulse beam on time is 10 μs, the number of pulses is one, and the irradiated area is φ150 μm. This table lists the damage ratio at the edge portion of processed hole after the smear removal process in the case of the conventional processing method without making the second laser irradiation, and the case where the energy density in the second laser irradiation conditions is changed from 0.1 to 0.6 J/cm².

Herein, the damage ratio is calculated based on how many processed holes with damage there are in 200 holes, irrespective of the degree of damage. ( [symbol] When damage is found in 100 holes through observation from the upper face by a microscope, the damage ratio is 100÷200=50%).

As shown in the table below, the damage ratio is drastically decreased, whereby the hardened layer prevents a damage at the edge portion of processed hole, as compared with the conventional method.

Damage ratio for the second laser irradiation conditions

| Second laser irradiation | | |
|---|---|---|
| condition (J/cm²) | Damage ratio (%) | Remarks |
| 0.0 | 32.5 | Conventional |
| | | processing |
| | | method |
| 0.1 | 1.5 | |
| 0.2 | 1.0 | |
| 0.3 | 0.5 | |
| 0.4 | 0.0 | |
| 0.5 | 0.5 | |
| 0.6 | 85.0 | Damage after |
| | | laser |
| | | irradiation |

(※ Epoxy resin was used.)

Herein, the hardening is explained.

The hardening is also called “bridging” to make the bonding formation between polymer chains by heating the resin to form polymer with a three-dimensional mesh structure. This phenomenon occurs in the hardening process for various thermosetting resins.

The hardening phenomenon is slightly varied depending on the kind of resin, but generally occurs at the former stage before the material reaches the boiling temperature.

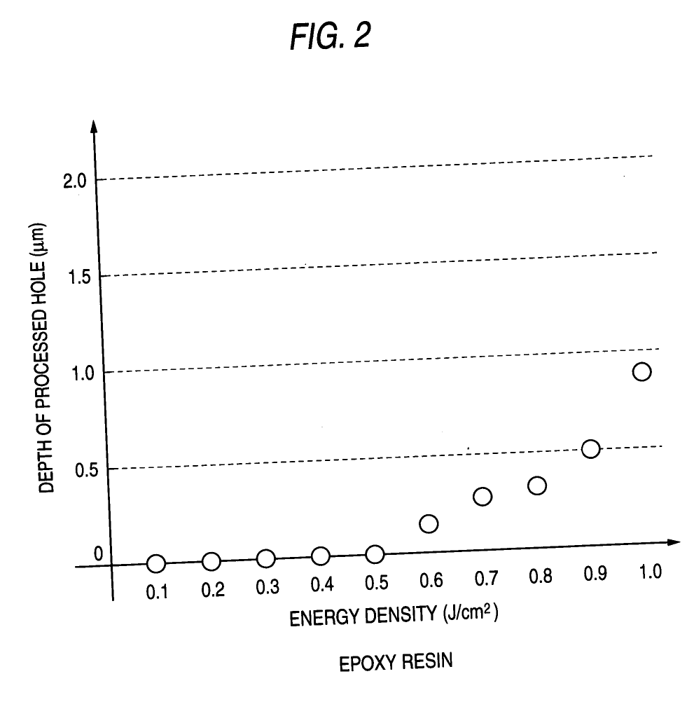

The hardened state and the depth of hardened layer are varied depending on the energy density of laser beam. From the results of FIG. 2, it will be found that the resin layer is not removed but hardened by applying a laser beam having an energy density of 0. 5 J/cm² or less, thereby preventing a damage at the edge portion of processed hole.

The laser irradiation conditions for forming the resin hardened layer 10 around the processed hole are set up as follows.

FIG. 2 is a graph showing the relationship between the energy density and the removal depth when a carbon dioxide gas laser beam having a wavelength of 10.6 μm is applied to epoxy resin.

As the preprocessing, the critical energy density beyond which the processing is not performed is acquired from the graph by varying the energy density in accordance with the resin to be processed.

For example, in a case of epoxy resin, if the energy density is 0.6 J/cm² or more, epoxy resin starts to be removed, the removal depth being increased, as shown in FIG. 2.

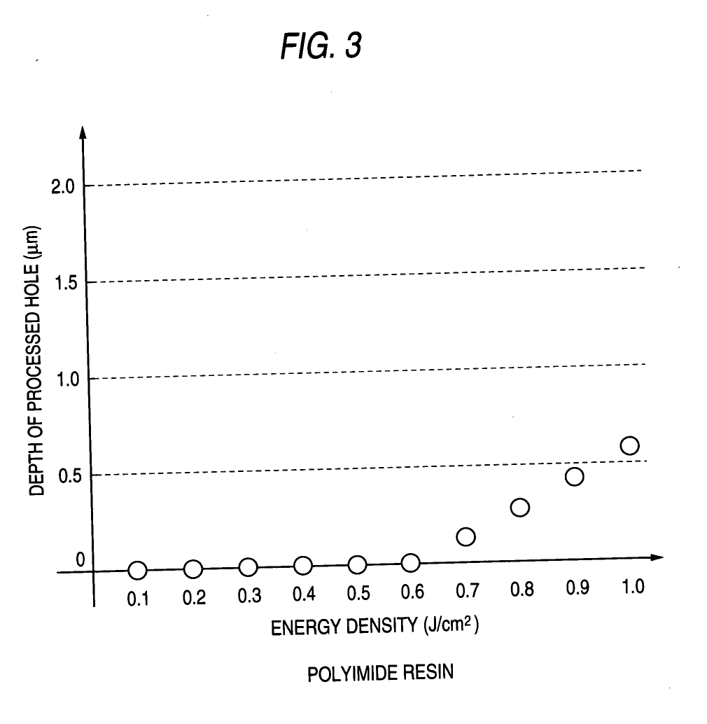

Also, in a case of polyimide, if the energy density is 0.7 J/cm² or more, polyimide starts to be removed, the removal depth being increased, as shown in FIG. 3.

As the second laser irradiation conditions, the energy density is set below the critical energy density as acquired from FIGS. 2 and 3, so that the hardened layer is formed around the processed hole, thereby preventing a damage in the processed hole from occurring in the smear removal process including liquid treatments.

In this embodiment, carbon dioxide gas laser beam having a wavelength of 10.6 μm is employed, and the energy density is set at 0.5 J/cm² or less as the second laser irradiation, whereby epoxy resin is not removed but hardened.

Though the resin smear remaining on the bottom face of the processed hole is also hardened, the resin smear can be removed through the smear removal process when the resin thickness is as small as 1 μm or less with the resin stick, because the bonding strength with the conductor layer 2 is lower.

To produce the hardened layer, carbon dioxide gas laser beam is suitable, but YAG laser having a wavelength of 1.06 μm also produces the hardened layer because heating process is made by molecular vibrations depending on the material.

Also, to implement this processing method, a processing machine having a movable lens for making the energy density variable and an aperture for making the irradiated area of laser beam variable as disclosed in JP-A-10-362422 is desirably employed.

### Embodiment 2

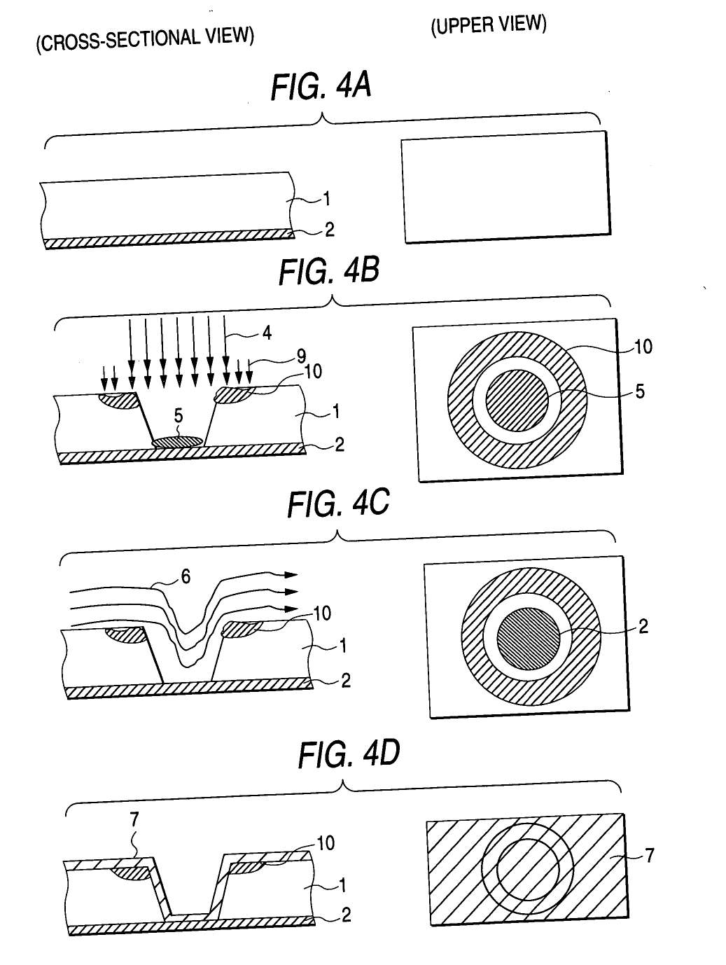

Referring to FIG. 4, a carbon dioxide gas laser material processing method for processing a laminated material according to a second embodiment of the invention will be described below.

In this embodiment, a printed wiring board has an insulating layer 1 made of epoxy resin and a conductor layer 2 made from a copper foil provided on the back face of the insulating layer 1, in which a blind hole up to the conductor layer 2 is formed through the insulating layer 1.

Herein, the printed wiring board is processed by the carbon dioxide gas laser material processing method for laminated material, and consists of the insulating layer 1 made of epoxy resin having a thickness of 60 μm and the conductor layer 2 made from a copper foil having a thickness of 18 μm, as shown in FIG. 4A.

The intended hole diameter of blind hole is φ80 μm.

As the first laser irradiation, a laser beam 4 having a pulse beam on time of 10 μs and an energy density of 15 J/cm², with an irradiated area of φ80 μm, for forming a hole in the insulating layer 1, and a laser beam 9 having a pulse beam on time of 10 μs and an energy density of 0.4 J/cm², with an irradiated area of φ150 μm, for hardening a surface of the insulating layer 1 around the processed hole are applied to the conductor layer 1 at the same time, thereby forming a resin hardened layer 10 while forming a hole in the insulating layer 1 (see FIG. 4B).

Thereafter, a smear removal process using potassium permanganate is performed to remove a smear 5 remaining on the surface of the conductor layer 2 after forming the hole (see FIG. 4C).

Lastly, a plating process including liquid treatments through an impurity removal process and a degreasing process is performed to make a plating, whereby the via hole formation for the printed wiring board is completed (see FIG. 4D).

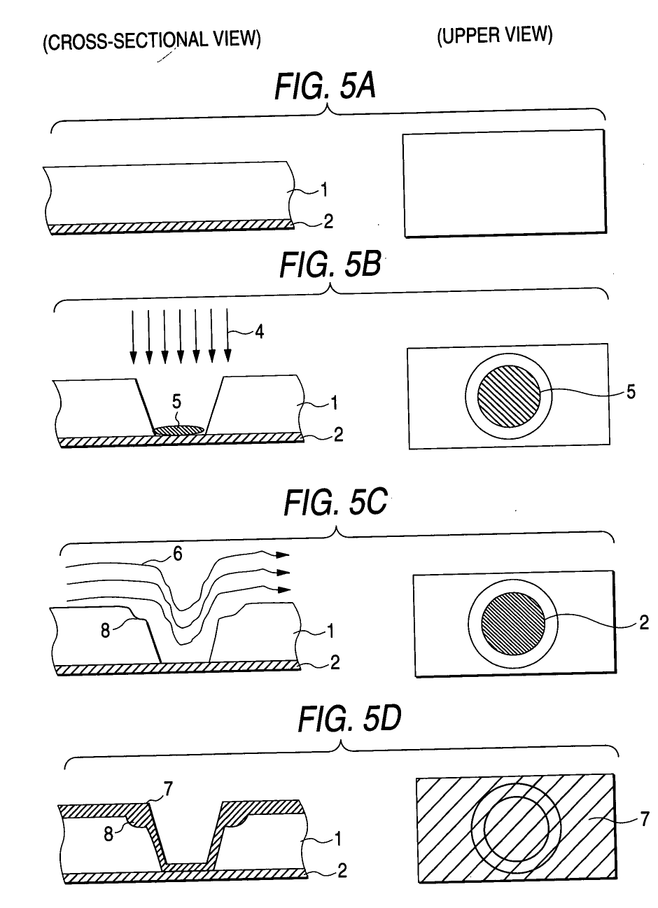

Referring to FIG. 5, comparison with the conventional technology will be now described.

Conventionally, since the smear removal process including liquid treatments was performed after removal of the resin layer by the laser beam 4, there occurred a damage 8 around the processed hole (see FIG. 5C), and the damage 8 was increased and plated in the subsequent plating process (see FIG. 5D).

The printed wiring board as fabricated conventionally had the damage in the processed hole opened by laser irradiation in the smear removal process including liquid treatments to cause a dispersion in the cross-sectional area of the processed hole, resulting in a problem that the electrical characteristics of the printed wiring board were unstable. However, in this embodiment, since the resin hardened layer 10 is formed around the processed hole of the insulating layer 1, the processed hole is not subjected to damage in the smear removal process, and similarly in the plating process.

Therefore, there is the effect that the electrical characteristics of the printed wiring board become stable.

For reference, a laser material processing method was disclosed in JP-A-54-8143 in which in forming a hole by laser beam, a hardening process is performed by applying laser beam to the processed surface of the workpiece to reduce the damage or extraneous matter caused by the laser material processing around the processed hole and then the hole is formed by laser beam. However, this patent has no detailed description about the designation of the workpiece and the laser beam conditions, and is not sufficient in terms of the laser beam conditions that are greatly variable to harden the workpiece.

Also, to reduce the damage or extraneous matter cause by the laser material processing, it is required to apply a laser beam for hardening at the former stage of the laser material processing, so that the hardened layer has some influence on the laser material processing, making it difficult to form the hole excellently.

In this invention, a laser beam for hardening is applied at the same time with or after the laser material processing, whereby the hardened layer has no influence on the laser material processing.

As described above, by using the laser material processing method according to the invention, there is the effect that the processed hole is not subjected to damage in the liquid treatment process including the smear removal process after the processing by laser beam.

### INDUSTRIAL APPLICABILITY

As described above, this laser material processing method is especially suitable for a carbon dioxide gas laser apparatus to form a through hole or a blind hole for electrical connection of a plurality of conductor layers in a laminated wiring board called a printed wiring board.

1. A laser material processing method for processing a printed wiring board to form a blind hole, a groove or a through hole by applying a laser beam to an insulating layer of said printed wiring board, comprising:
processing said insulating layer at a predetermined energy density;
hardening said insulating layer by applying a laser beam at a lower energy density than said predetermined energy density of said first step around a processed portion processed in the processing step; and
removing the residual smear.

2. The laser material processing method according to claim 1, wherein the energy density is 0.5 J/cm² or less in the hardening step.

3. The laser material processing method according to claim 1, wherein the energy density is 0.6 J/cm² or less in applying laser beam to said insulating layer made of polyimide resin in the hardening step.

4. The laser material processing method according to claim 1, wherein the area to apply laser beam in the hardening step is about double the processed area in the processing step.

5. The laser material processing method according to claim 1, wherein a carbon dioxide gas laser having a wavelength of 10.6 μm is used for the laser material processing.

6. A laser material processing method for processing a printed wiring board to form a blind hole, a groove or a through hole by applying a laser beam to an insulating layer of said printed wiring board, comprising:
processing said insulating layer at an energy density of 15 J/cm²;
hardening said insulating layer by applying a laser beam at an energy density of 0.5 J/cm² or less around a processed portion processed in the processing step; and
removing the residual smear.

7. The laser material processing method according to claim 1, wherein one pulse of laser beam is applied for a pulse beam on time of 10 μs in the hardening step.

8. The laser material processing method according to claim 1, wherein laser irradiation in the processing step and laser irradiation in the hardening step are performed at the same time.

9. The laser material processing method according to claim 6, wherein one pulse of laser beam is applied for a pulse beam on time of 10 s in the hardening step.

10. The laser material processing method according to claim 6, wherein laser irradiation in the processing step and laser irradiation in the hardening step are performed at the same time.
